(19) United States
(12) Patent Application Publication
(10) Pub. No.: US 2012/0100442 A1
(43) Pub. Date: Apr. 26, 2012

(54) OXYGEN-CONSUMING ELECTRODE AND PROCESS FOR PRODUCING IT

(75) Inventors: Andreas Bulan, Langenfeld (DE); Jürgen Kintrup, Leverkusen (DE); Matthias Weis, Leverkusen (DE)

(73) Assignee: Bayer MaterialScience AG, Leverkusen (DE)

(21) Appl. No.: 13/271,752

(22) Filed: Oct. 12, 2011

(30) Foreign Application Priority Data
Oct. 21, 2010 (DE) 10 2010 042 729.2

(51) Int. Cl. H01M 4/90; C25B 11/06; C25B 9/00; H01M 12/06; C25B 11/02

(52) U.S. Cl. 429/405; 429/528; 204/286.1; 204/242

(57) ABSTRACT

An oxygen-consuming electrode includes a support in the form of a sheet-like structure and a coating including a gas diffusion layer and a catalytically active component, wherein the support is based on a material having a conductivity of less than 1000 S/cm, measured at 20° C. The supports are simple to produce and have a low weight and good processability in the production of the oxygen-consuming electrodes.

### CROSS REFERENCE TO RELATED APPLICATIONS

Priority is claimed to German Patent Application No. 10 2010 402 729, filed Oct. 21, 2010, the disclosures of which is incorporated herein by reference in its entirety for all useful purposes.

### BACKGROUND

The field of the present invention relates to an oxygen-consuming electrode, in particular for use in chloralkali electrolysis, having a novel support and also an electrolysis apparatus. The field of the present invention further relates to the use of this oxygen-consuming electrode in chloralkali electrolysis or in fuel cell technology.

The invention proceeds from oxygen-consuming electrodes known per se which are configured as gas diffusion electrodes and usually comprise an electrically conductive support and a gas diffusion layer having a catalytically active component.

Various proposals for operating the oxygen-consuming electrodes in electrolysis cells of an industrial size are known in principle from the prior art. The basic idea is to replace the hydrogen-evolving cathode in the electrolysis (for example in chloralkali electrolysis) by the oxygen-consuming electrode (cathode). An overview of possible cell designs and solutions may be found in the publication by Moussallem et al “Chlor-Alkali Electrolysis with Oxygen Depolarized Cathodes: History, Present Status and Future Prospects”, J. Appl. Electrochem. 38 (2008) 1177-1194.

The oxygen-consuming electrode, hereinafter also referred to as OCE for short, has to meet a number of requirements in order to be able to be used in industrial electrolysers. Thus, the catalyst and all other materials used have to be chemically stable to sodium hydroxide solution having a concentration of about 32% by weight and to pure oxygen at a temperature of typically 80-90° C. A high measure of mechanical stability is likewise required since the electrodes are installed and operated in electrolysers having a size of usually more than 2 m² in area (industrial size). Further properties are: a high electrical conductivity, a low layer thickness, a high internal surface area and a high electrochemical activity of the electrocatalyst. Suitable hydrophobic and hydrophilic pores and an appropriate pore structure for the conduction of gas and electrolyte are likewise necessary, as is impermeability so that gas space and liquid space remain separated from one another. Long-term stability and low production costs are further particular requirements which an industrially usable oxygen-consuming electrode has to meet.

A conventional oxygen-consuming electrode typically consists of an electrically conductive support onto which the gas diffusion layer having a catalytically active component has been applied. As hydrophobic component, use is made of, for example, polytetrafluoroethylene (PTFE) which additionally serves as polymeric binder for the catalyst. In the case of electrodes having a silver catalyst, the silver serves as hydrophilic component.

A metal, a metal compound, a non-metallic compound or a mixture of metal compounds or non-metallic compounds generally serves as catalyst. However, metals, in particular metals of the platinum group, applied to a carbon support are also known. Silver catalysts have been found to be particularly useful for the electrolysis of alkali metal chlorides using oxygen-consuming electrodes.

In the production of OCEs having a silver catalyst, the silver can be at least partly introduced in the form of silver (I) or silver (II) oxides which are then reduced to metallic silver, The reduction is carried out either in the initial phase of the electrolysis in which conditions for reduction of silver compounds prevail or in a separate step by electrochemical, chemical or other means known to those skilled in the art before the electrode is taken into operation. The reduction of the silver compounds also results in a change in the arrangement of the crystallites, in particular to bridge formation between individual silver particles. This leads overall to a strengthening of the structure.

In the production of oxygen-consuming electrodes, a distinction may be made in principle between dry and wet manufacturing processes.

In the dry processes, a mixture of catalyst and a polymeric component is milled to fine particles which are subsequently distributed on the electrically conductive support element and pressed at room temperature. Such a process is described in EP 1728896 A2. EP 1728896 A2 describes silver, silver(I) oxide, silver(II) oxide or mixtures thereof as preferred catalysts, polytetrafluoroethylene (PTFE) as binder and a mesh made of nickel wires having a wire diameter of 0.1-0.3 mm and a mesh opening of 0.2-1.2 mm as support.

In the wet manufacturing processes, either a paste or a suspension of catalyst and polymeric components is used. Surface-active substances can be added in the production of the pastes or suspension in order to increase the stability of the latter. The pastes are applied to the support element by screen printing or calendering, while the less viscous suspensions are usually sprayed on to the support element. The paste or suspension is, after rinsing out the emulsifier, gently dried and then sintered at temperatures in the region of the melting point of the polymer. Such a process is described, for example, in US20060175195 A1.

Earlier publications also disclose processes in which the mixture of catalyst and polymer is densified in a first step to form a sheet-like structure (“rolled sheet”) and this structure is then pressed into the support element. Examples of such processes are described in DE10148599 A1 or EP0115845B1. Since these sheet-like structures have a low mechanical stability, these processes have been found to be of little use in industrial practice. Preference is therefore given to those processes in which the support element is firstly coated with a mixture of catalyst and polymer and densification and strengthening are carried out in further steps.

The support elements are woven meshes of conductive material, for example a woven mesh of nickel wires, silver wires or silver-coated nickel wires. It is also possible to use other structures such as knitteds, braids, nonwovens, expanded metals, perforated metal plates, foams or other permeable structures made of conductive materials.

Carbon is likewise used in various forms for support elements, for example woven fabrics or papers made of carbon fibres. To increase the conductivity, the carbon can be combined with metal components, for example by deposition of metal onto the carbon or by mixed fabrics made of carbon fibres and metallic fibres and filaments.

WO2008006909 A2 describes the production of an OCE having a mesh of silver wires as electrically conductive support element.

EP 1728896 A2 describes the production of an OCE having a mesh of nickel wires as electrically conductive support element.

EP1033419B1 describes the production of an OCE having a support element composed of silver-coated foamed nickel.

US 4578159A1 discloses metal-coated fibres for possible use in support elements for oxygen-consuming electrodes.

US20060175195 A1 describes the production of OCEs having various carbon-based supports.

According to the prior art, the support elements have two essential functions: they firstly serve as mechanical support for the catalyst-containing layer during and after manufacture of the electrodes and secondly serve for distribution of current to the reaction sites.

The conventional supports have various disadvantages.

The production of fabrics/meshes, nonwovens, sponge-like structures or other structures composed of metals is very complicated.

Metals have a high specific gravity and thus the support elements made of metals also have a relatively high intrinsic weight, which makes handling and transport more difficult.

The production of carbon fibres and the processing thereof to produce sheet-like structures such as woven fabrics is likewise complicated. Carbon fibres have the further disadvantage that they promote the formation of hydrogen peroxide since this reduces the performance of the electrode.

A further disadvantage is that other supports which are preferably used according to the prior art consist entirely of silver or are at least coated with silver. The high price of silver increases the costs for producing the corresponding oxygen-consuming electrodes, which has an adverse effect on the economics of their use. The present invention may therefore provide an oxygen-consuming electrode, in particular for use in chloralkali electrolysis, which overcomes the above disadvantages.

### DESCRIPTION OF PREFERRED EMBODIMENTS

The present invention may provide an oxygen-consuming electrode which avoids the disadvantages of the known supports and is based on supports which can be produced simply and inexpensively and are easy to handle.

This may be achieved by oxygen-consuming electrodes based on supports which are based on materials which have a high electrical resistance or are electrically nonconductive and can be produced simply and inexpensively and are easy to handle. It has surprisingly been found that such materials which have a high electrical resistance or are electrically nonconductive are highly suitable as support elements for oxygen-consuming electrodes without the performance of the oxygen-consuming electrode being adversely affected.

An oxygen-consuming electrode (OCE) may comprise a support in the form of a sheet-like structure and a coating comprising a gas diffusion layer and a catalytically active component, wherein the support is based on a material having a conductivity of less than 1000 S/cm, preferably less than 100 S/cm, measured at 20° C.

The materials for the support of the OCE have conductivities which are significantly lower than those of metals (conductivity of silver: 62 MS/cm (megasiemens/cm), conductivity of nickel: 14.5 MS/cm) and also of carbon fibres (conductivity: 10³-10⁴ S/cm). These are classical insulators (conductivity<10⁻⁸ S/cm), but it is also possible to use intrinsically nonconductive materials whose conductivity has been increased by means of additives such as conductive carbon black and in particular polymers which are filled with carbon nanotubes and have a conductivity of <1000 S/cm.

Suitable materials for the support are in particular polymers and mineral fibres.

Particularly suitable polymers are, for example, polyethylene, polypropylene, chlorinated polyolefins, polyvinyl chloride, polymers of fluorinated olefins such as polytetrafluoroethylene, polyvinyl fluoride, polyvinylidene fluoride, melamine, polyacrylonitrile, polyamide 6, polyamide 6.6, polyamide 11, polyamide 12, aromatic polyamides such as Kevlar®, polycarbonate, polystyrene and copolymers such as ABS, SAN, ASA, polyphenylene oxide, polyurethane, polyethylene terephthalate, polybutylene terephthalate, polyether ether ketone, polysulphone, polyimide, polyetherimide, polyamide imide, polyarylate, polyphenylene sulphide, polyvinyl acetate, ethylene-vinyl acetate, polyvinylidene chloride, PMMA, polybutylenes, cellulose acetate, polylactides and copolymers and blends of the polymers mentioned. Preference is given to using polypropylene, polymers of fluorinated olefins, in particular polytetrafluorethylene, polyvinyl fluoride, polyphenylene sulphide, particularly preferably polytetrafluoroethylene.

Particularly suitable mineral fibres are glass fibres, particularly those made of E glass, E-CR glass, R glass, S glass, A glass, C glass, D glass, AR glass, particularly preferably AR glass, and mineral fibres composed of boron, boron nitride, silicon carbide, zirconium oxide, aluminium oxide, basalt or quartz.

However, it is also possible to use, in particular, cellulose-based natural materials such as cotton or sisal.

It is likewise possible to use, in particular, combinations of the abovementioned materials,

In one variation, electrically conductive components having a conductivity >1,000 S/cm, for example metal wires, in particular metal wires based on nickel, silver, can also be incorporated into the sheet-like structure of the support, in particular in a proportion of up to 10% by weight.

As material for the support, preference is given to alkali- and/or oxygen-resistant materials. However, it is also possible to use materials which are not resistant to alkali and oxygen. In this case, it should be noted that contamination of the electrolyte occurs in the start-up phase of the oxygen-consuming cathode. In the preparation of alkali metal hydroxides, it is necessary to take precautions for handling of the contaminated alkali obtained in the initial phase, for example separate storage and subsequent use in fields in which the contamination is tolerated.

The supports can be used in the form of woven fabrics/meshes, knitteds, nonwovens, perforated films, foams or other permeable sheet-like structures. Preference is given to using woven fabrics/meshes. It is also possible to use multilayer structures, for example two or more layers of woven fabrics/meshes, knitteds, nonwovens, perforated films, foams or other permeable sheet-like structures. The layers can have different thicknesses and have different mesh openings or perforations. The supports or precursors thereof can be treated with sizes or other additives to improve processability.

A preferred form of the oxygen-consuming electrode is characterized in that the gas diffusion layer is based on a fluorinated polymer, in particular polytetrafluoroethylene, and optionally catalytically active material in addition.

In a likewise preferred embodiment, the catalytically active component is selected from the group consisting of: silver, silver (I) oxide, silver (II) oxide and mixtures thereof, in particular a mixture of silver and silver (I) oxide.

It is important that the materials and structures selected meet the mechanical requirements in the manufacture and handling of the OCE.

Thus, supports made of materials which have a high electrical resistance or are nonconductive can be used in the dry process mentioned. Preference is given to supports composed of alkali-resistant materials, for example woven fabrics made of polymer monofilaments such as polypropylene. The woven fabrics of the polymer monofilaments are sufficiently dimensionally stable and can be coated using the techniques described. Strengthening of the catalytically active composition is effected without introduction of heat, so that the structure and strength of the support element are retained.

In comparison to the woven metal meshes which can be used as support material according to the prior art, woven fabrics made of polymer monofilaments have a lower intrinsic weight, a lower sensitivity to creasing and can generally be handled more readily.

This is advantageous in a continuous or semicontinuous rolling process, especially with a view to the production of large numbers of electrodes. Woven fabrics made of polymer monofilaments can easily be unwound from a roll and readily drawn into and fed into a calender.

In the same way, supports made of materials which have a high electrical resistance or are not conductive can be used in the wet production process mentioned. Preference is given to alkali-resistant material having a softening point of the material which is above the temperature in the sintering step, for example woven fabrics made of AR glass or of aromatic polyamides such as Kevlar®.

The oxygen-consuming electrode is preferably connected as cathode, in particular in an electrolysis cell for the electrolysis of alkali metal chlorides, preferably sodium chloride or potassium chloride, particularly preferably sodium chloride.

As an alternative, the oxygen-consuming electrode can preferably be connected as cathode in a fuel cell.

The oxygen-consuming electrode may also be used for the reduction of oxygen in an alkaline medium, in particular in an alkaline fuel cell, the use in mains water treatment, for example for the preparation of sodium hypochlorite, or use in chloralkali electrolysis, in particular for the electrolysis of LiCl, KCl or NaCl, preferably of NaCl, or use in a metal/air battery.

An electrolysis apparatus, in particular an NaCl electrolysis cell, and an alkaline fuel cell, may also comprise the oxygen-consuming electrode.

The oxygen-consuming electrode is particularly preferably used in chloralkali electrolysis and here especially in the electrolysis of sodium chloride (NaCl).

All the references described above are incorporated by reference in their entireties for all useful purposes.

As used herein, the singular terms “a” and “the” are synonymous and used interchangeably with “one or more” and “at least one,” unless the language and/or context cleary indicates otherwise. Accordingly, for example, reference to “a catalytically active component” herein or in the appended claims can refer to a single catalytically active component or more than one catalytically active component. Additionally, all numerical values, unless otherwise specifically noted, are understood to be modified by the word “about.”

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLE

3.5 kg of a powder mixture consisting of 7% by weight of PTFE powder, 88% by weight of silver(I) oxide and 5% by weight of silver powder of the grade 331 from Ferro were mixed at a rotational speed of 6000 rpm in an Eirich model R02 mixer equipped with a star spinner as mixing element in such a way that the temperature of the powder mixture did not exceed 55° C. This was achieved by the mixing operation being interrupted and the mixture being cooled in a cooling chamber. Mixing was carried out a total of three times. After mixing, the powder mixture was sieved by means of a sieve having a mesh opening of 1.0 mm.

The sieved powder mixture was subsequently applied to a propylene monofilament mesh having a wire thickness of 0.25 mm and a mesh opening of 0.5 mm. Application was carried out with the aid of a 2 mm thick template, with the powder being applied by means of a sieve having a mesh opening of 0.1 mm. Excess powder which projected above the thickness of the template was removed by means of a scraper. After removal of the template, the support together with the applied powder mixture was pressed by means of a roller press at a pressing force of 0.5 kN/cm. The finished gas diffusion electrode was taken from the roller press.

The gas diffusion electrode produced in this way was used as oxygen-consuming cathode in the electrolysis of a sodium chloride solution using a DuPONT N982WX ion-exchange membrane and a sodium hydroxide gap between OCE and membrane of 3 mm. The cell potential at a current density of 4 kA/m², an electrolyte temperature of 90° C. and a sodium hydroxide concentration of 32% by weight.

The measured cell potential is therefore comparable to that of an electrode based on a nickel mesh as support. Advantages of the electrode are its lighter weight (about 1 kg less than a comparable Ni-based electrode having an area of 2 m²) and its easier installation owing to the lower weight and its greater mechanical flexibility.

1. An oxygen-consuming electrode comprising a support in the form of a sheet-like structure and a coating comprising a gas diffusion layer and a catalytically active component, wherein the support is based on a material having a conductivity of less than 1000 S/cm, measured at 20° C.

2. The oxygen-consuming electrode according to claim 1, wherein the support is based on a material having a conductivity of less than 100 S/cm.

3. The oxygen-consuming electrode according to claim 1, wherein the support is based on a polymer.

4. The oxygen-consuming electrode according to claim 3, wherein the polymer is selected from the group consisting of: polypropylene, polymers of fluorinated olefins, polyvinyl fluoride, polyphenylene sulphide, and mixtures thereof.

5. The oxygen-consuming electrode according to claim 3, wherein the polymer comprises polytetrafluoroethylene.

6. The oxygen-consuming electrode according to claim 3, wherein the polymer comprises polypropylene.

7. The oxygen-consuming electrode according to claim 1, wherein the support is based on mineral fibres.

8. The oxygen-consuming electrode according to claim 7, wherein the support is based on glass fibres.

9. The oxygen-consuming electrode according to claim 7, wherein the support is based on glass fibres comprising a glass selected from the group consisting of: E glass, E-CR glass, R glass, S glass, A glass, C glass, D glass, AR glass, and mixtures thereof.

10. The oxygen-consuming electrode according to claim 9, wherein the support is based on glass fibres comprising AR glass.

11. The oxygen-consuming electrode according to claim 1, wherein the material of the support is alkali-resistant and/or oxidation-resistant.

12. The oxygen-consuming electrode according to claim 1, wherein the sheet-like structure comprises at least one electrically conductive component having a conductivity of greater than 1,000 S/cm.

13. The oxygen-consuming electrode according to claim 12, wherein the at least one electrically conductive component comprises metal wires.

14. The oxygen-consuming electrode according to claim 13, wherein the metal wires comprise nickel, titanium, and/or silver.

15. The oxygen-consuming electrode according to claim 12, wherein the at least one electrically conductive component is incorporated into the sheet-like structure of the support in a proportion of up to 10% by weight.

16. The oxygen-consuming electrode according to claim 1, wherein the sheet-like structure of the support is in the form of a woven fabric/mesh, knitted, nonwoven, perforated film, or foam.

17. The oxygen-consuming electrode according to claim 1, wherein the gas diffusion layer is based on a fluorinated polymer and optionally a catalytically active material.

18. The oxygen-consuming electrode according to claim 1, wherein the catalytically active component is selected from the group consisting of: silver, silver (I) oxide, silver (II) oxide and mixtures thereof.

19. An alkaline fuel cell or a metal/air battery comprising the oxygen-consuming electrode according to claim 1.

20. An electrolysis apparatus comprising the oxygen-consuming electrode according to claim 1 as an oxygen-consuming cathode.
